(19) United States
(12) Patent Application Publication
(10) Pub. No.: US 2017/0044896 A1
(43) Pub. Date: Feb. 16, 2017

(54) Real-Time Calculation of Maximum Safe Rate of Penetration While Drilling

(71) Applicant: Weatherford Technology Holdings, LLC, Houston, TX (US)

(72) Inventor: Kent P. Salminen, Houston, TX (US)

(21) Appl. No.: 14/824,613

(22) Filed: Aug. 12, 2015

(51) Int. Cl. E21B 49/00; E21B 44/00; G05B 19/042; E21B 7/00

(52) U.S. Cl. CPC E21B 49/003; E21B 7/00; E21B 44/00; G05B 19/042

(57) ABSTRACT

Drilling a borehole involves a drilling system that uses drilling mud to transport cuttings of a formation to surface. During the operation, current parameters are obtained of the drilling operation conducted with the drilling system. The current parameters at least include a cuttings parameter related to the cuttings produced in the drilling operation. A current concentration of the cuttings is determined in the drilling operation based on the obtained parameters, and a desired rate of penetration for the drilling operation is determined based on the determined concentration. Based on the determined rate, a current rate of penetration is altered in an effort, for example, to mitigate issues with stuck pipe, damage to drilling components, reduced drilling efficiency, etc.

### BACKGROUND OF THE DISCLOSURE

Stuck pipe while drilling can be a common problem in the oil industry. In fact, stuck pipe has become a more significant source of non-productive time because extended reach horizontal drilling has gained use in unconventional shale plays. Unfortunately, stuck pipe is often difficult to detect until after the sticking event has already occurred.

Typically, drilling jars are run to provide a way to “un-stick” the drill string. Yet, extended reach horizontal drilling has changed traditional thinking because it reduces the effectiveness of jars by limiting force transfer from the vertical section to the horizontal section of the well. For this reason, many operators have stopped running drilling jars in these types of wells. Consequently, operators have very few ways to detect/prevent stuck pipe so that in some sense nothing can be done to address the issue if it occurs.

Other than using drilling jars, many operators mandate pumping high viscosity “sweeps” at some regular interval while drilling. A typical frequency involves one sweep for every three stands of pipe drilled. The “sweeps” are meant to clean the borehole near the bit and reduce the changes of sticking.

Operators also rely on the expertise of rig site supervisors to be able to detect when the well is being drilled “too fast” and/or if any of the telltale signs of impending stuck pipe are being observed at the surface. Operators may also supplement these efforts by having a remote tactical operations center (RTOC) monitor drilling operations remotely.

Historically, raw real-time data may be plotted during drilling. To determine an appropriate rate of penetration, operators rely on human interpretation of whether the pump pressure, torque, hookload, and other parameters fall outside of the “normal” or “acceptable” ranges. Changes to rate of penetration (ROP) in what is sometimes called “controlled drilling” can be made based on human judgement. For example, limits can be placed on ROP based on experience in the area (i.e. operators may merely know how fast drilling was proceeding when the last problem occurred). Additionally, limits can be placed on ROP based on the ability of surface equipment to simply clean out solids from the mud coming through the flow line.

As will be appreciated, the above methods are highly subjective and may be unreliable. In many instance, a drilling regime used at one well is simply just copied to the next well without regard to changes in geology, drilling conditions, etc. In short, current techniques to mitigate stuck pipe during drilling are insufficient.

What is needed is a real-time system to proactively calculate a desired rate-of-penetration (ROP) during a drilling operation to mitigate issues with stuck pipe. The subject matter of the present disclosure is directed to overcoming, or at least reducing the effects of, one or more of the problems set forth above.

### SUMMARY OF THE DISCLOSURE

According to the present disclosure, a method of drilling a borehole with a drill tool (e.g., drill bit) of a drilling system uses drilling mud to transport cuttings of a formation to surface. The method involves obtaining current parameters of a drilling operation conducted with the drilling system. The current parameters at least include a cuttings parameter related to the cuttings produced in the drilling operation. The method involves determining a current concentration of the cuttings in the drilling operation at least near the drill tool based on the obtained parameters and involves determining a desired rate of penetration for the drilling operation based on the determined concentration. In the method, a current rate of penetration is altered based on the determined rate.

The current parameters can include one or more of: a weight of the drilling mud, a flow rate of the drilling mud, the current rate of penetration of the drilling system, a depth of the borehole, a depth of the drill tool (e.g., bit) of the drilling system, a density of the cuttings, a diameter of the cuttings, an eccentricity factor of the borehole, and a porosity of the formation.

To determine the current concentration of the cuttings in the drilling operation based on the current parameters, the method can use a volumetric flow rate of the drilling mud, a volumetric flow rate of the cuttings, and a relationship between slip velocity and axial velocity in the determination. Additionally, the method can use in the determination one or more of: an area of an annulus at a bottom hole assembly of the drilling system, an eccentricity of the borehole, a surface area of a drill tool (e.g., bit) of the drilling system, and a porosity of the formation. Eccentricity of the borehole as described herein refers to enlargement of the cross-sectional area of the borehole due to breakouts, washouts, spiraling, etc. and should not be simply confused with the common definition of eccentricity that refers to the drillstring being off-center within the borehole

Determining the desired rate of penetration from the drilling operation based on the determined concentration involves determining a limit of the desired rate of penetration. In this way, to alter the current rate of penetration based on the determined rate, the current rate can be altered to at least below the limit.

In one arrangement, determining the desired rate of penetration from the drilling operation based on the determined concentration involves obtaining from historical data a correlation relating a given cuttings concentration to a maximum rate of penetration for a given operating condition. Put another way in another arrangement, determining the desired rate of penetration for the drilling operation based on the determined concentration involves correlating the determined concentration at a given operating condition at least to a historical cuttings concentration for the given operating condition in historical drilling information, and calculating a maximum rate of penetration from the historical cuttings concentration. The historical drilling information can include drilling operations in which detrimental stuck pipe events occurred.

Altering the current rate of penetration based on the determined rate can include altering a weight applied to a drilling assembly of the drilling system in the borehole.

According to the present disclosure, a program storage device can have program instructions stored thereon for causing a programmable control device to perform a method of drilling a borehole as described above.

According to the present disclosure, a drilling system is for drilling a borehole using drilling mud to transport cuttings of a formation to surface. The system includes storage, an interface, and a processing unit. The storage stores historical information. The interface obtains current parameters of a drilling operation conducted with the drilling system. The current parameters at least include a cuttings parameter related to the cuttings produced in the drilling operation. The processing unit is in communication with the storage and the interface and is configured to determine a current concentration of the cuttings in the drilling operation based on the obtained parameters. The processing unit is configured to determine a desired rate of penetration for the drilling operation based on the determined concentration correlated with the historical information, and to alter a current rate of penetration based on the determined rate.

The foregoing summary is not intended to summarize each potential embodiment or every aspect of the present disclosure.

### BRIEF DESCRIPTION OF THE DRAWINGS

FIG. 1A illustrates a rig of a drilling system for the present disclosure.

FIG. 1B illustrates additional details of the drilling system for the present disclosure.

FIG. 2 illustrates a schematic representation of a control system for the disclosed drilling system.

FIG. 3A diagrams a bottom hole assembly drilling a borehole with cuttings and velocities depicted.

FIG. 3B diagrams an end view of the borehole annulus with pipe rotation depicted.

FIG. 3C diagrams an end view of a borehole annulus with cuttings.

FIG. 4 illustrates a process of drilling with the drilling system and accounting for a maximum rate of penetration based on a concentration of cuttings.

FIG. 5 illustrates a plot of actual rate of penetration relative to a maximum “safe” rate of penetration for a particular example well in which stuck pipe occurred.

FIG. 6 schematically illustrates historical data sets with historical parameters used for correlations to real-time data and current parameters so as to track the rate of penetration relative to a calculated maximum rate of penetration.

### DETAILED DESCRIPTION OF THE DISCLOSURE

A drilling system uses the teachings of the present disclosure when drilling a borehole in a drilling operation as drilling mud conducts cuttings of the formation to surface. Used with such a system, the teachings of the present disclosure determine a maximum “safe” rate of penetration for drilling the borehole to mitigate chances of a stuck pipe incident or other detrimental outcome. As will be discussed in more detail below, the maximum “safe” rate of penetration applies to given operating conditions determined from historical data compared with current parameters related to how cutting concentrations occur at or near the bottom hole assembly of the drilling system. “Safe” in general refers to an acceptable or allowable rate of penetration to avoid or limit the chances of a stuck pipe or other detrimental event.

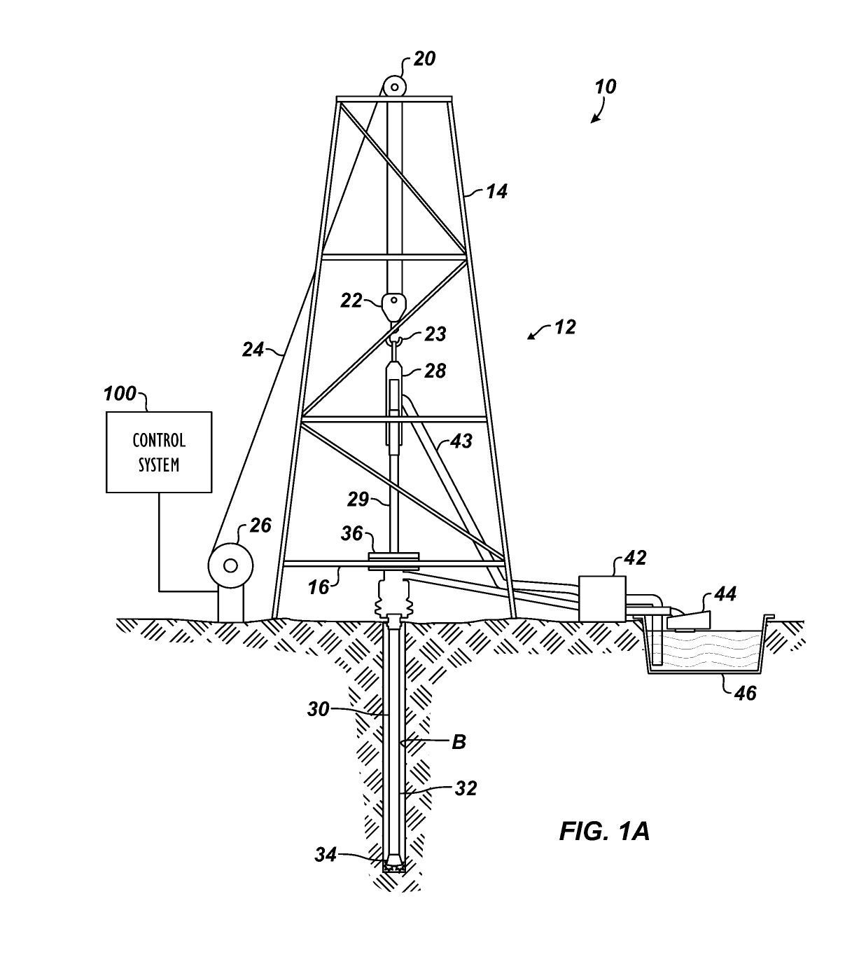

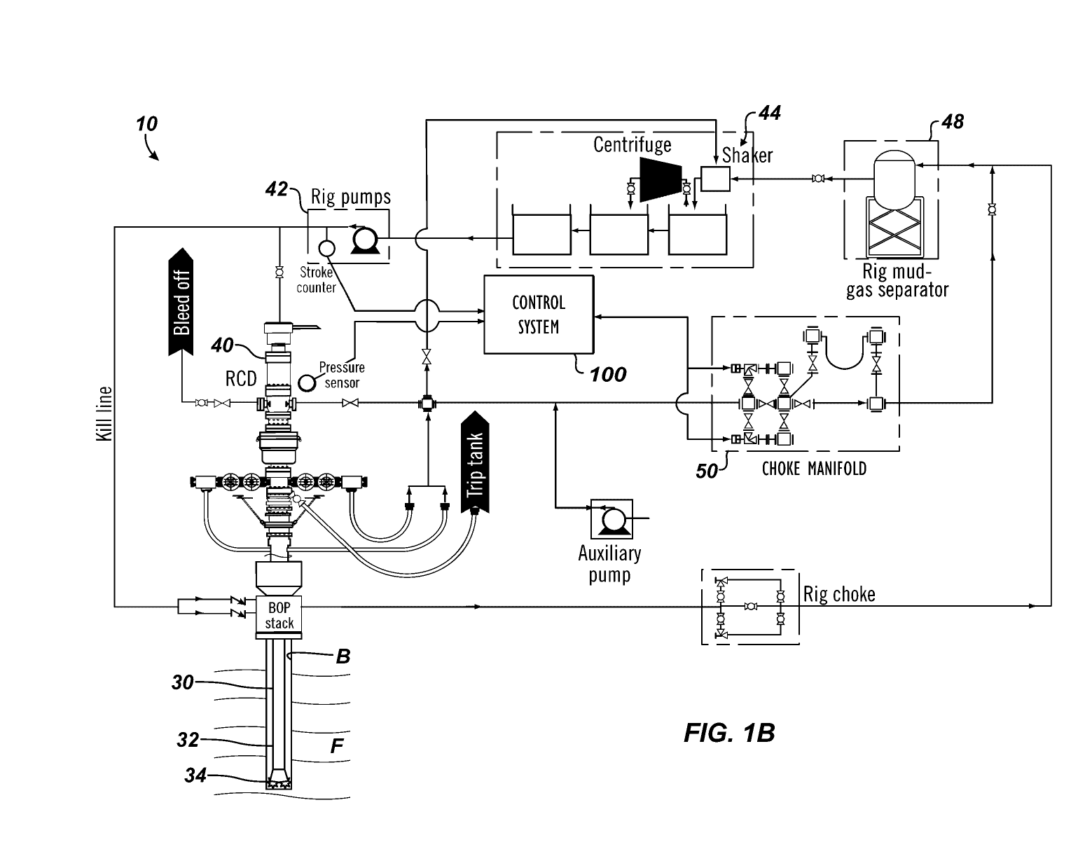

Various types of drilling systems can benefit from the teachings of the present disclosure, such as a rotary drilling system 10 illustrated in FIG. 1A. The rotary drilling system 10 includes a drilling rig 12, which can be a land rig or any other type of rig. The drilling rig 12 can be a conventional rotary rig that performs drill string rotation using a rotary table 36 turning a Kelly bushing 29. Those skilled in the art will appreciate that the rig 12 can use other drilling technologies, such as a top drive, a power swivel, downhole hydraulic motors, coiled tubing units, and the like.

As shown in this example, the drilling rig 12 has a mast 14 supported on the rig's floor 16 and has lifting gear including a crown block 20 and a traveling block 22. The crown block 20 is mounted on the mast 14 and is coupled to the traveling block 22 by a cable 24, which is driven by draw works 26. During drilling operations, the draw works 26 controls the upward and downward movement of the traveling block 22 with respect to the crown block 20.

For its part, the traveling block 22 includes a hook 23. A swivel 28 suspended by the hook 23 supports a kelly 29, which in turn supports the drill string 30 suspended in the wellbore B. Extending downhole, the drill string 30 has interconnected stands of drill pipe and a bottom hole assembly (BHA) 32, which may include components such as a drill tool (e.g., drill bit) 34, stabilizers, drill collars, measurement while drilling (MWD) instruments, rotary steerable tool, and the like.

As best shown in the diagram of FIG. 1B, the drilling system 10 may be a closed loop system that uses a rotating control device (RCD) 40 from which the drill string 30 and the bottom hole assembly (BHA) 32 extend downhole into the wellbore B through a formation F. The rotating control device 40 can include any suitable pressure containment device that keeps the wellbore in a closed-loop at all times while the wellbore B is being drilled.

The system 10 also includes mud pumps 42, a shaker 44, a mud tank 46, a mud gas separator 48, and various flow lines, as well as other conventional components. In addition to these, the drilling system 10 can include a choke manifold 50 that is incorporated into the other components of the system 10.

Finally, a control system 100 of the drilling system 10 is centralized and integrates hardware, software, and applications across the drilling system 10. The centralized control system 100 is used for monitoring, measuring, and controlling parameters in the drilling system 10.

During drilling operations, the drill string 30 is rotated in the borehole B by the rotary table 36 as shown in FIG. 1A on the rig floor 16 engaging with the kelly 29. The mud pumps 42 deliver drilling fluid or “mud” to the drill string 30 through a mud hose 43 connected to the swivel 28. To drill through the formation F, rotary torque and axial force are applied to the drill bit 34 so that the drill bit 34 cuts into and breaks up the formation F as the bit 34 is rotated. The pumped drilling mud exits at the drill bit 34 and carries the formation cuttings produced by the bit 34 up the annulus between the drill string 30 and the borehole B so the equipment for handling cuttings (e.g., shakers, etc.) can remove the cuttings from the drilling fluid.

This axial force applied to the drill bit 34 during drilling is referred to as the “Weight-on-bit” (WOB), which is a function of the weight of the drill string 30 in the drilling mud less any support from the rig 12, friction, etc. The “rotary torque” refers to the torque applied to the drill string 30 at the drilling rig 12 to turn the drill string 30. The speed at which the rotary table 36 rotates the drill string 30 is typically measured in revolutions per minute (RPM) and is referred to as the “rotary speed.” The rate at which the drill bit 34 penetrates the formation F being drilled is referred to as the “rate of penetration” (ROP).

Generally, the rate of penetration (ROP) during drilling increases with increased weight on bit (WOB) until an upper limit for the rate of penetration is reached for a particular drill bit 34 and drilling environment. Additional weight on bit (WOB) beyond this limit typically results in a decreased rate of penetration, damage to the drill bit 34, and the like. Accordingly, each particular drill bit 34 and drilling environment may have an optimum weight on bit (WOB) that reaches this upper ROP limit during drilling.

Because the drill string 30 extends a substantial depth, the mere weight of the drill string 30 itself can typically be greater than any optimum or desired weight on bit to be used for drilling. For this reason, the drilling rig 12 supports some of the weight of the drill string 30 during drilling. The weight on bit (WOB) can typically be calculated as a weight of the drill string 30 in the drilling mud minus the amount of weight suspended by the rig's hook 23. The portion of the weight of the drill string 30 supported by the hook 23 is typically referred to as the “hookload.” Any weight of the drill string 30 supported by the wall of the wellbore B may also be subtracted.

Other drilling systems can use mud motors, rotary steerable tools, underreamers, milling tools, etc. and can operate in a similar manner to the drilling system described above. Of course, as one exception for some of these other drilling systems, drill string rotation or other operations may not be used or applicable, but weight on bit and rate of penetration are still applicable terms to such other types of drilling systems.

During the drilling operations as noted above, the cuttings are introduced to the flow stream at the bit face when the cutters on the drill bit 34 break the bulk rock into smaller pieces. For drilling to continue without problems, these cuttings must be circulated out of the wellbore annulus and removed from the drilling fluid by surface solids control equipment, such as shakers 44 and the like. The ability of the drilling fluid to carry these cuttings to surface depends on the mud properties, the cutting properties, flow rate, borehole geometry, and the like.

During drilling, the control system 100 of the present disclosure uses cuttings data directly to determine a maximum “safe” ROP for drilling. To do this, equations for particle slip velocity, axial velocity, rate of penetration, and rock properties are combined with real-time and historical drilling data. From this, the control system 100 of the present disclosure can calculate a volumetric concentration of drilled cuttings in the annulus at or near the bottom hole assembly 32 (e.g., at or near the drill bit 34).

As is understood, the volumetric concentration of drilling cuttings should be kept below some upper limit, typically quoted as 5%. However, through study of historical data sets, it can be shown that the “real” limit is significantly lower than this. It can also be shown that stuck pipe incidents are strongly associated with exceeding a maximum value of the volumetric concentration of drilling cuttings. Based then on historical data and calculations disclosed below, a new parameter of “Maximum Safe Rate of Penetration” is derived for any given rock formation. The control system 100 can calculate this maximum “safe” rate of penetration in real-time during drilling and can use the results as a basis for optimizing drilling operations, automating drilling functions, etc. to mitigate stuck pipe issues.

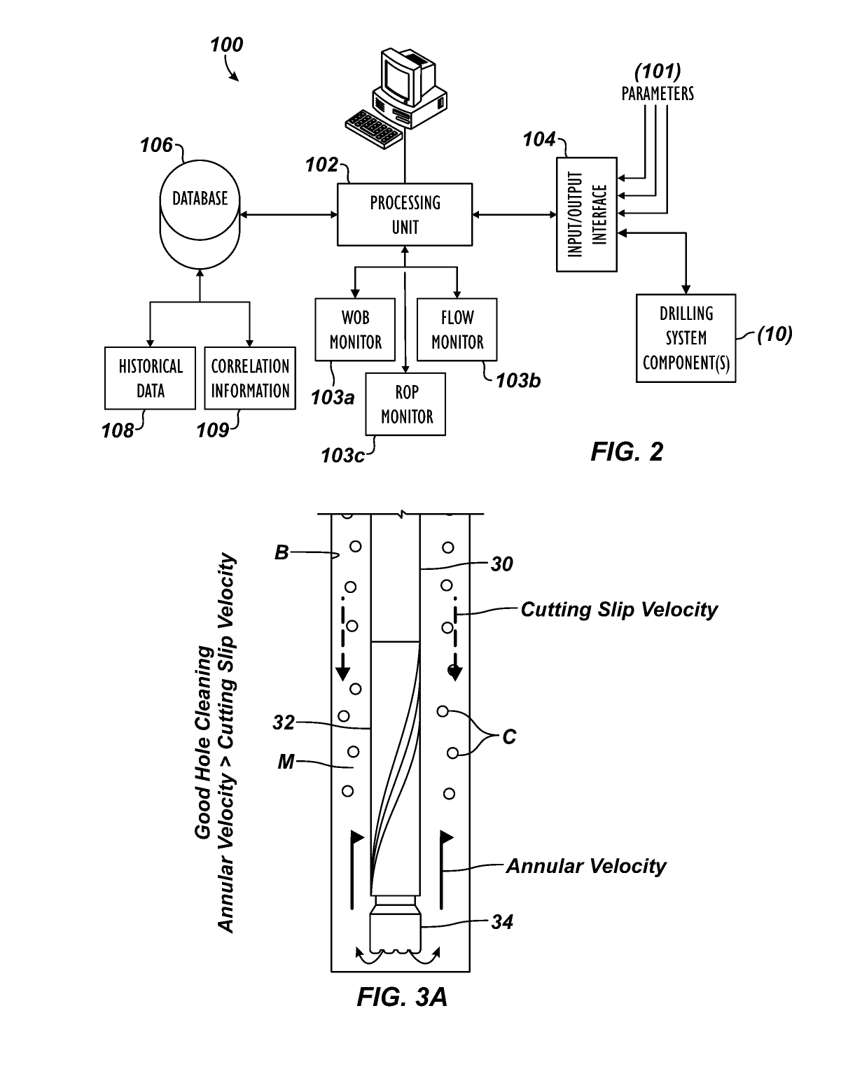

With an overall understanding of the drilling system 10, discussion now turns to example features of the control system 100 of the present disclosure. The control system 100 is schematically shown in FIG. 2. As briefly depicted, the control system 100 includes a processing unit 102, which can be part of a computer system, a server, a programmable logic controller, etc. The processing unit 102 has a number of monitors or controls 103a-b used for monitoring or control during drilling operations. As shown herein, the processing unit 102 operates a monitor 103a for weight-on-bit, a monitor 103b for flow, and a monitor 103c for ROP to name a few.

Using input/output interfaces 104, the processing unit 102 can communicate with various components of the drilling system 10 to obtain information on parameters and to communicate with various sensors, actuators, and logic control for the various system components as the case may be. In terms of the current controls discussed, signals communicated to the drilling system's components can be related to controls for altering the rate of penetration of the drilling system 10 in the drilling operation. The signals can include, but are not limited to, signals to control the flow rate, weight on bit, hookload, RPM, rotary torque, etc.

The processing unit 102 also communicatively couples to a database or storage 106 having historical data 108, correlation information 109, and other stored information. The historical data 108 characterizes the cuttings concentrations, ROP, etc. with stuck pipe incidents based on previous drilling operations. The correlation information 109 is compiled from the historical data based on the analysis disclosed herein and can be organized and characterized based on borehole types, borehole depths, drilling fluids, operating conditions, and other scenarios and arrangements.

Before going into further details of the drilling system 10, the control system 100, and the drilling process, discussion first turns to how a maximum “safe” rate of penetration is determined based on a concentration of cuttings at or near the bottom hole assembly 32 (e.g., drill tool or bit 34). In terms of the present disclosure, the concentration of cuttings can be determined at the drill bit or at least near the drill bit (i.e., around the area of the bottom hole assembly 32 having the drill bit 34). As is customary, the bottom hole assembly 32 of a drilling system typically has a drill tool or bit 34 and can have a number of other components, such as stabilizers, drill collars, measurement while drilling (MWD) instruments, rotary steerable tool, and the like. The overall size and length of the bottom hole assembly depends on a number of factors, such as desired weight on bit, weight of the drill collar, mud weight, buoyancy, etc.

Based on a mass balance for cuttings entering the flow stream and the ability to remove them, the control system 100 can calculate a cuttings concentration at the bit face and the near-bit area at any given time for both historical and real-time data. This is termed cuttings concentration f_{c}.

In particular, the control system 100 stores information that is based on historical data sets and that correlates calculated cuttings concentration f_{c} versus depth for on-bottom drilling where problems such as stuck pipe occurred. The stored information establishes an empirical “safe” or “acceptable” cuttings concentration f_{c} for drilling under various drilling parameters. The “safe” cuttings concentration f_{c} may vary based on the inclination of the borehole, type of BHA, formation properties or type (e.g. shale, limestone, etc.), mud weight, current drilling operation (connection, pump sweep, rotary drilling, etc.) and other factors.

The control system 100 obtains relevant drilling data in real-time while drilling from an available data stream, such as available in Wellsite Information Transfer Specification (WITS) or Wellsite Information Transfer Standard Markup Language (WITSML) data streams. The relevant drilling data can be supplemented with various user inputs, such as mud weight and the like. The control system 100 may also use log data.

Using the stored information and the real-time data, the control system 100 can calculate a “safe” or “acceptable” cuttings concentration f_{c} for drilling, which in turn can provide a maximum “safe” ROP at any given time or depth.

Equations used by the control system 100 for calculating the “safe” cuttings concentration f_{c} and maximum “safe” ROP for drilling will now be discussed.

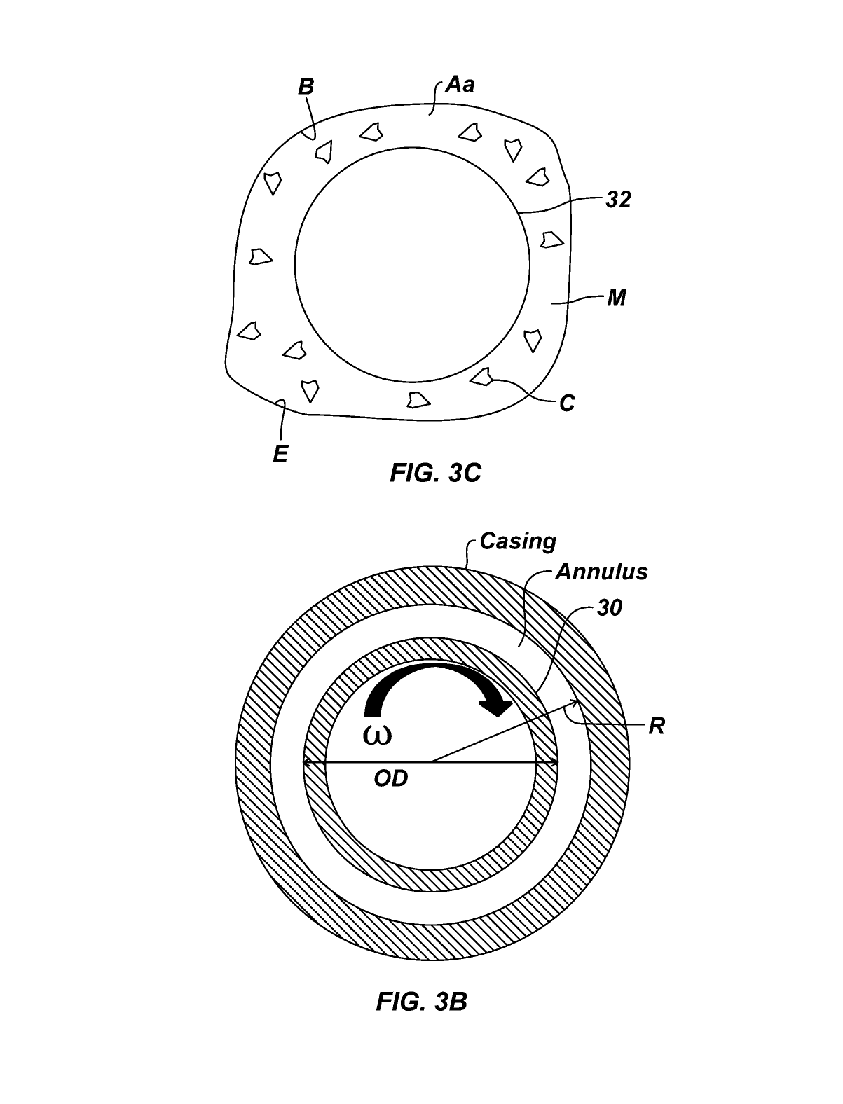

As discussed herein, a Cuttings Transport Ratio (CTR) is characterized as a relationship between cutting slip velocity (vₛₗ) and axial velocity (vₐ). FIG. 3A diagrams cutting slip velocity (vₛₗ) and axial velocity (vₐ) of cuttings in a borehole B drilled by a drill bit 34 of a bottom hole assembly 32. For good borehole cleaning, the axial velocity (vₐ) of the cuttings is preferably greater than cutting slip velocity (vₛₗ). The Cuttings Transport Ratio (CTR) can thereby be characterized as:

$$CTR = \frac{{v}_{a} - {v}_{sl}}{{v}_{a}} = 1 - \frac{{v}_{sl}}{{v}_{a}}$$

where:

$${v}_{a} = \frac{24.5 q}{( 1 + {ε}_{e} ) [ {( ID )}^{2} - {( OD )}^{2} ]} … ( ft \text{/} min ) ,$$

q=flow rate (gpm) of the drilling mud,

ID=inside diameter of the borehole (in),

OD=outside diameter of BHA (in), and

∈ₑ=eccentricity factor (dimensionless) of the borehole.

Under the assumption that flow is always turbulent near the bit 34 and the BHA 32, then the slip velocity (vₛₗ) can be characterized as:

$${v}_{sl} = 1.54 \sqrt{{d}_{cutting} ( \frac{{ρ}_{cutting} - {ρ}_{mud}}{{ρ}_{mud}} )} … ( ft \text{/} sec )$$

where:

d_{cutting}=cuttings diameter (in),

ρ_{cutting}=cuttings density (ppg), and

ρ_{mud}=mud density (ppg).

As already noted, the contribution to the velocity from the axial fluid flow can be characterized as:

$${v}_{a} = \frac{24.5 q}{[ {( {ID}_{hole} )}^{2} - {( {OD}_{pipe} )}^{2} ] \times [ 1 + {ɛ}_{e} ]} = [ ft \text{/} min ]$$

Yet, the total velocity near the bit 34 can include some contribution from pipe rotation and fluid coupling in addition to the contribution from axial fluid flow noted above. The contribution from pipe rotation and fluid coupling relates to an angular velocity calculation. Consideration of the angular velocity uses some assumptions, such as no slip condition at the drill pipe and casing wall, Bingham plastic fluid behavior, shear stress in all regions of the annulus is greater than yield stress, and non-constant values across the annulus. As schematically depicted in FIG. 3B, the angular velocity in the annulus around the drill pipe can be characterized as:

$${v}_{angular} = ω - \frac{α R}{2}$$

where:

$$ω = angular velocity of drill pipe = \frac{( RPM ) ( {OD}_{pipe} ) ( π )}{12} = [ ft \text{/} min ] ;$$

$$α = \frac{PV}{{θ}_{100}} \approx rate of decrease in angular fluid velocity due to pipe rotation with distance from drill pipe = [ \frac{Δ ft \text{/} min}{inches} ] ;$$

$$\frac{R}{2} = midpoint between drill pipe OD and casing ID = [ inches ] .$$

With respect to pipe rotation and borehole cleaning, these factors play a more significant role in inclined/horizontal wellbores. With that in mind, the angular velocity can be characterized as:

$${v}_{{angular}_{—} eff} = λ ( ω - \frac{α R}{2} ) sin Θ$$

where:

λ accounts for cuttings bed disruption and experimentally determined factors; and

sin Θ maximizes effect of pipe rotation in a horizontal well, minimizes it in a vertical well.

It should be noted that the increase in allowable ROP due to pipe rotation (as described above) would only be considered when the CTR is positive based on axial fluid flow contributions. In other words, fluid flow must be sufficient to clean the wellbore on its own before any increased hole cleaning capability due to pipe rotation would be considered. This is so because a positive ROP is not really possible when there is zero fluid flow.

Because velocity is a vector quantity, total velocity for use in the CTR value can be:

vₜₒₜₐₗ=\sqrt{vₐₓᵢₐₗ²+v_{angular}²}

This velocity term vₜₒₜₐₗ can replace the term vₐ in the equation for CTR and subsequently for the cuttings concentration f_{c} to improve the analysis of cuttings concentration in determining a limit for a maximum rate of penetration.

For another method of assessing borehole cleaning, mixed density can be measured at surface and compared to a theoretical value. The mixed density can be characterized as:

ρₘᵢₓ=f_{c}ρ_{c}+(1−f_{c})(ρₘ)

Given the above determinations, the Cuttings Transport Ratio (CTR) can be determined. Any non-zero (positive) CTR value indicates that cuttings are being transported to the surface. However, there is a limit to the cutting concentration f_{c} that can be tolerated for safe drilling, as discussed previously, otherwise the drilling assembly may become stuck. To determine this limit, a volumetric flow rate of cuttings (i.e., “Cuttings Feed Rate” (q_{c})) is first defined as:

$${q}_{c} = 0.1247 {A}_{bit} ( 1 - ∅ ) \frac{d D}{d t} ( 1 + {ε}_{e} ) … ( gpm )$$

where:

A_{bit}=bit surface area (ft²),

Ø=average porosity (dimensionless),

$$\frac{d D}{d t} = rate of penetration ( ft \text{/} hr ) ,$$

and

∈ₑ=eccentricity factor (dimensionless).

The annulus of the borehole B as schematically shown in FIG. 3C around the bottom hole assembly 32 can be visualized as a cross-section of constant area (Aₐ) with some concentration of cuttings C in the drilling mud M. As depicted, borehole breakout has an effect on cuttings accumulation in the borehole B because the eccentricity (∈ₑ) of the borehole B effectively increase the annular area (Aₐ).

Using this understanding of the concentration of cuttings C in the borehole B, the volumetric flow rate of cuttings (“Cuttings Feed Rate” (q_{c})) can be characterized as:

q_{c}=Aₐf_{c}(vₐ−vₛₗ) . . . (ft³/min)

where:

Aₐ=annular area including eccentricity (ft²),

f_{c}=cuttings concentration (dimensionless by volume),

vₐ=annular velocity (ft/min), and

vₐ=slip velocity (ft/min).

Similarly, because drilling mud M is also transported in the borehole annulus, the volumetric flow rate of mud M at any point in the well can be characterized as:

qₘ=Aₐ(1−f_{c})(vₐ) . . . (ft³/min).

If it is assumed that there are no fluid losses (or the losses are low), qₘ can be taken to be equal the mud flow rate from surface. Combining the “Cuttings Feed Rate” (q_{c}) and the volumetric flow rate of mud with the equation for Cuttings Transport Ratio (CTR) produces the following expression (1) for cuttings concentration f_{c}:

$${f}_{c} = \frac{{q}_{c}}{{q}_{c} + ( CTR ) {q}_{m}} … ( dimensionless ) , or {f}_{c [ {q}_{c} + ( CTR ) ( {q}_{m} ) ] } = {q}_{c} .$$

The control system 100 can track and plot this term for the cuttings concentration f_{c} in real-time.

Replacing the “Cuttings Feed Rate” (q_{c}) term with its explicit definition provides:

$${f}_{c} ( CTR ) ( {q}_{m} ) = ( 1 - {f}_{c} ) [ ( 0.1247 ) ( {A}_{bit} ) ( 1 - ∅ ) ( \frac{d D}{d t} ) ( 1 + {ε}_{e} ) ]$$

Maximum “safe” or “allowable” ROP is then found by rearranging the cuttings concentration f_{c} and solving for the rate of penetration

$$( \frac{d D}{d t} ) .$$

Solving for the rate of penetration

$$( \frac{d D}{d t} )$$

gives the following expression (2) for the rate of penetration:

$$\frac{d D}{d t} = 8.02 \frac{{f}_{c} ( CTR ) ( {q}_{m} )}{( 1 - {f}_{c} ) ( {A}_{bit} ) ( 1 - ∅ ) ( 1 + {ε}_{e} )}$$

The stored information accessed by the control system 100 includes historical data sets, which has values for ROP mud weight, weight-on-bit, flow rate, cuttings diameter, drill bit area, etc. The historical data sets has been examined with the first expression (1) to determine maximum allowable cuttings concentrations f_{c} for given borehole types and other factors. Using this maximum cuttings concentration f_{c}, the stored information can include calculations from expression (2) of the maximum “safe” ROP at any given depth for the given borehole types.

Likewise, the real-time data accessed by the control system 100 includes values for ROP, mud weight, weight-on-bit, flow rate, cuttings diameter, drill bit area, etc. The real-time data is examined with the first expression (1) to determine a cuttings concentrations f_{c} for the given parameters. Using this cuttings concentration f_{c}, the control system can calculate a value for the ROP from expression (2) for analysis.

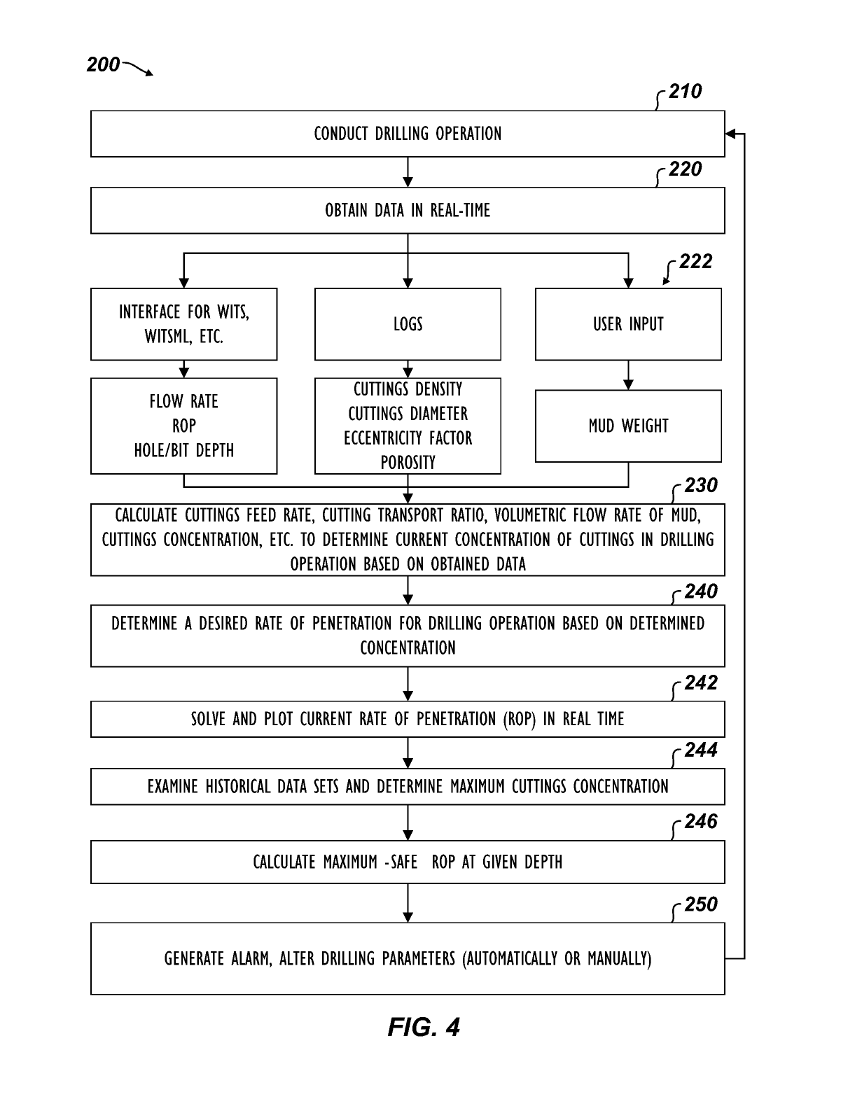

With an understanding of the expressions and forms of data involved in the system 10 as well as some of the various components involved, discussion now turns to an example drilling process in which a maximum “safe” ROP is determined in real-time at a given depth to direct various drilling functions. Turning to FIG. 4, a drilling process 200 according to the present disclosure is depicted in flow chart form. (For better understanding, reference to previously described elements is concurrently made.)

In the drilling process 200, the drilling system 10 drills a borehole B in a drilling operation that uses drilling mud M to transport cuttings C of a formation F to surface (Block 210). As the drilling system 10 conducts the drilling operation, the control system 100 obtains current parameters of the drilling operation (Block 220). The current parameters 222 at least include a cuttings parameter related to the cuttings produced in the drilling operation. More particularly, the control system 100 obtains information on parameters 222 related to a weight of the drilling mud, flow rate of the drilling mud, the current rate of penetration of the drilling system, a depth of the borehole, a depth of a drill bit of the drilling system, a density of the cuttings, a diameter of the cuttings, an eccentricity factor of the borehole, and a porosity of the formation.

Some of the inputs can be user inputs into the system 10 and can include mud weight, physical characteristics of the drilling system, etc. Other inputs are obtained during drilling in real-tem from the available data stream and include inputs for flow rate, actual rate of penetration, borehole depth, drill bit depth, and the like. Still other inputs are obtained using logs and can include cuttings density from well logs, cuttings diameter from mud logs, eccentricity factor of the borehole from a caliper log, and porosity from well logs.

In the process 200, the control system 100 determines a current concentration f_{c} of the cuttings C in the drilling operation based on the obtained parameters 222 (Block 230). To do this, the control system 210 uses a volumetric flow rate of the drilling mud M, a volumetric flow rate of the cuttings C, and a relationship between slip velocity (vₛₗ) and axial velocity (vₐ) according to the analysis discussed previously. Additional considerations noted above for the determination of the cuttings concentration f_{c} involve the area (Aₐ) of the annulus at the bottom hole assembly 32 of the drilling system 10, an eccentricity E of the borehole B, a surface area of a drill bit 34 of the drilling system 10, and a porosity of the formation F.

Continuing in the process 200, the control system 100 determines a desired rate of penetration for the drilling operation based on the determined concentration (Block 240). This desired rate of penetration can be expressed as a limit or a maximum rate of penetration for the drilling operation. Here, the control system 100 plots calculated values for the ROP in real-time and compares them to the maximum “safe” ROP at the current depth of the current borehole type as expressed in the stored historical information. The calculation is performed in real-time as drilling data is gathered from the data stream. The maximum “safe” ROP is plotted vs. time and/or depth and compared to the current or actual ROP.

As discussed previously, for example, the control system 100 solves and plots the current rate of penetration in real-time based on the analysis discussed previously (Block 242). Based on the examination of historical data sets and a determination of the maximum cuttings concentration f_{c} for the given depth, operation, etc. (Block 244), the control system 100 calculates the maximum “safe” rate of penetration for the given operation at the given depth (Block 246).

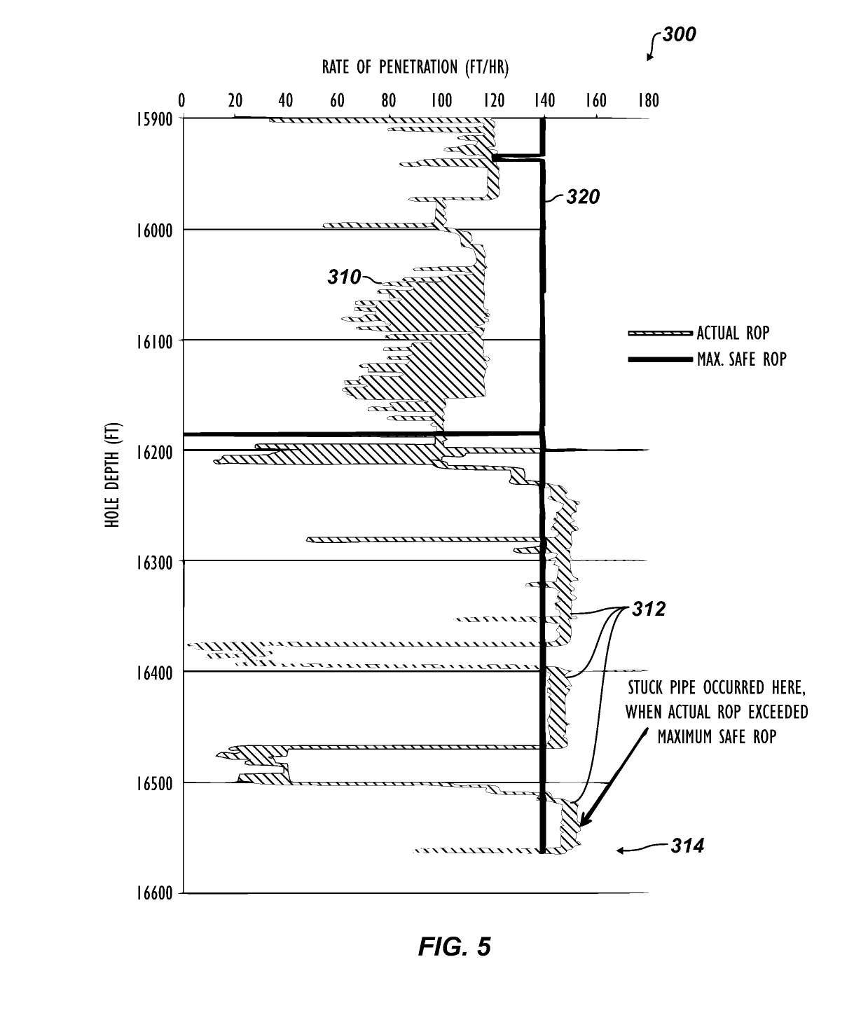

As a brief example, FIG. 5 illustrates a graph 300 comparing an actual rate of penetration 310 with a maximum safe rate of penetration 320 per hole depth as a drilling operation is conducted. The maximum safe rate of penetration 320 is shown here as being relatively constant, but this may not always be the case depending on the operational conditions and the like. The actual ROP 310 and the “safe” ROP 320 are calculated based on the analysis herein with consideration of the cuttings concentration, historical data sets, and the like discussed previously.

The actual rate of penetration 310 fluctuates with the operating conditions. At certain points 312 during drilling, operations have brought the actual ROP 310 above the “safe” ROP 320. Ultimately, a stuck pipe incident occurred at a point 314 in the drilling operation when the actual ROP 310 was brought above the “safe” ROP 320. This historical data therefore provides correlations between drilling parameters, ROP, cuttings concentration, and the like for the given operation conditions. Multiple sets of such data as this can be analyzed to compile stored information for comparative and correlative purposes as discussed herein.

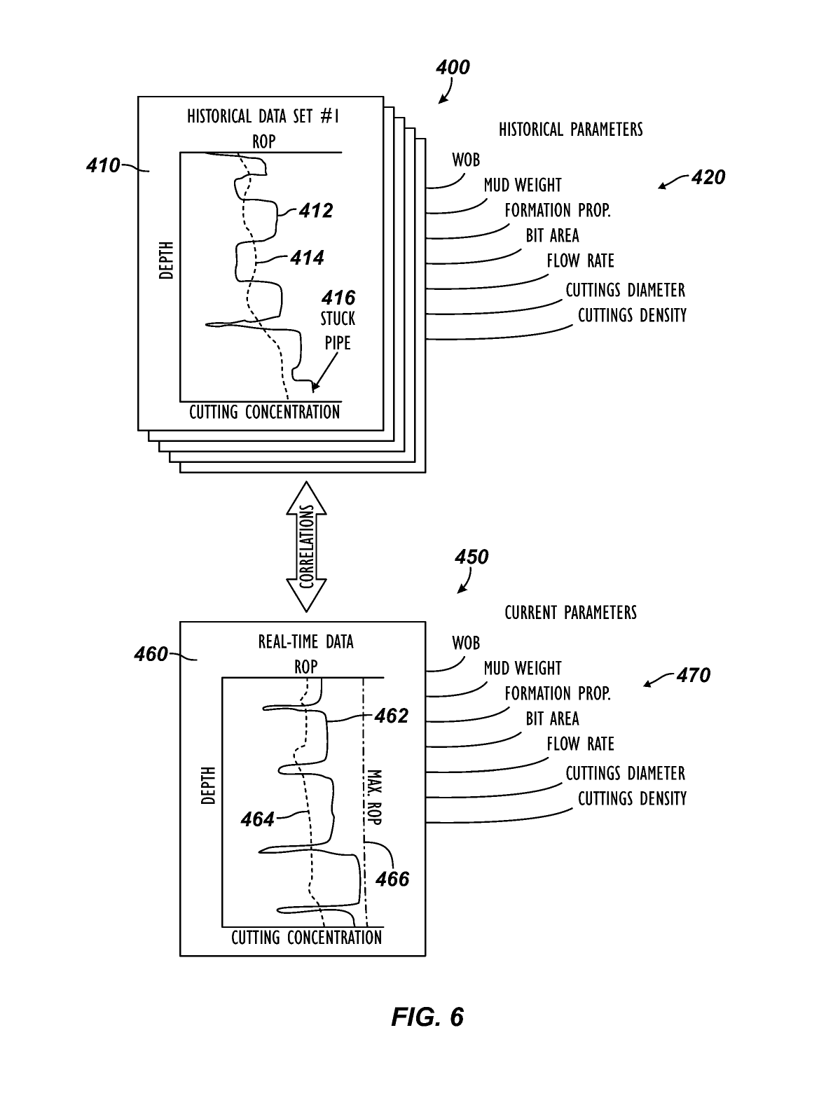

For example, FIG. 6 schematically illustrates historical data sets having historical parameters. These historical data sets are used for correlations to real-time data and current parameters of a drilling operation. As disclosed herein, the historical data sets can include information about ROP, depth, stuck pipe events, weight-on-bit (WOB), mud weight, formation properties, bit area, flow rate, cuttings diameter, cuttings density, etc. The real-time data and current parameters can include comparable information. Calculations as disclosed herein can be used to determine cuttings concentrations and to determine the ROP value based on such a determined cuttings concentration as disclosed herein. In the end, the correlations are used to track the current rate of penetration relative to a calculated maximum rate of penetration determined through analysis.

Returning to the process 300 of FIG. 4, the control system 100 can ultimately use the comparison of desired and current ROPs to provide feedback to the operators, to alter auto-drilling functions, etc. (Block 250), and the entire process 200 can be repeated on a cyclical basis. Based on the comparison, for instance, the current (actual) rate of penetration can be altered based on the determined (“safe”) rate. In particular, the current rate of penetration can be brought to a level that is at least below the limit or maximum “safe” rate of penetration determined. Alerts can be sent to drilling personnel if the limit is exceeded.

Altering the current rate of penetration based on the determined rate can involve altering a weight applied to the drilling assembly of the drilling system in the borehole. Other parameters can be altered as an alternative or in addition to the weight-on-bit. The alteration can be performed manually by an operator based on alarms or other information provided to the operator from the computer system. Alternatively, for a drilling system 10 having a level of automation, the control system 100 can alter parameters of the drilling operation to alter the rate of penetration during current drilling. The alteration can be combined with an ROP estimation model so drilling parameters (WOB, torque, RPM, etc.) can be chosen automatically in automated drilling. Because various drilling parameters (WOB, torque, RPM, etc.) are related to ROP, the control system 100 can determining optimum values for these drilling parameters (WOB, torque, RPM, etc.) to alter the actual or current ROP.

As will be appreciated, teachings of the present disclosure can be implemented in digital electronic circuitry, computer hardware, computer firmware, computer software, or any combination thereof. Teachings of the present disclosure can be implemented in a programmable storage device (computer program product tangibly embodied in a machine-readable storage device) for execution by a programmable control device or processor so that the programmable processor executing program instructions can perform functions of the present disclosure. The teachings of the present disclosure can be implemented advantageously in one or more computer programs that are executable on a programmable system including at least one programmable processor coupled to receive data and instructions from, and to transmit data and instructions to, a data storage system, at least one input device, and at least one output device. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of drilling a borehole with a drill tool of a drilling system that uses drilling mud to transport cuttings of a formation to surface, the method comprising:
obtaining current parameters of a drilling operation conducted with the drilling system, the current parameters at least including a cuttings parameter related to the cuttings produced in the drilling operation;
determining a current concentration of the cuttings in the drilling operation at least near the drill tool based on the obtained parameters;
determining a desired rate of penetration for the drilling operation based on the determined concentration; and
altering a current rate of penetration based on the determined rate.

2. The method of claim 1, wherein obtaining the current parameters comprises obtaining one or more of: a weight of the drilling mud, flow rate of the drilling mud, the current rate of penetration of the drilling system, a depth of the borehole, a depth of the drill tool of the drilling system, a density of the cuttings, a diameter of the cuttings, an eccentricity factor of the borehole, and a porosity of the formation.

3. The method claim 1, wherein determining the current concentration of the cuttings in the drilling operation at least near the drill tool based on the current parameters comprises using a volumetric flow rate of the drilling mud, a volumetric flow rate of the cuttings, and a relationship between slip velocity and axial velocity in the determination.

4. The method of claim 3, wherein determining the current concentration of the cuttings in the drilling operation at least near the drill tool based on the current parameters further comprises using in the determination one or more of: an area of an annulus at least near the drill tool, an eccentricity of the borehole, a surface area of the drill tool of the drilling system, and a porosity of the formation.

5. The method claim 1, wherein determining the desired rate of penetration from the drilling operation based on the determined concentration comprises determining a limit of the desired rate of penetration; and wherein altering the current rate of penetration based on the determined rate comprises altering the current rate relative to the limit.

6. The method of claim 1, wherein determining the desired rate of penetration from the drilling operation based on the determined concentration comprises obtaining from historical data a correlation relating a given cuttings concentration at least near a given drill tool to a maximum rate of penetration for a given operating condition.

7. The method of claim 1, wherein determining the desired rate of penetration for the drilling operation based on the determined concentration comprises correlating the determined concentration at a given operating condition at least to a historical cuttings concentration for the given operating condition in historical drilling information, and calculating a maximum rate of penetration from the historical cuttings concentration.

8. The method of claim 7, wherein the historical drilling information at least comprises a drilling operation in which a detrimental stuck pipe event occurred.

9. The method claim 1, wherein altering the current rate of penetration based on the determined rate comprises altering a weight applied to the drill tool of the drilling system in the borehole.

10. A program storage device having program instructions stored thereon for causing a programmable control device to perform a method of drilling a borehole according to claim 1.

11. A drilling system for drilling a borehole with a drill tool using drilling mud to transport cuttings of a formation to surface, the system comprising:
storage storing historical information;
an interface obtaining current parameters of a drilling operation conducted with the drilling system, the current parameters at least including a cuttings parameter related to the cuttings produced in the drilling operation; and
a processing unit in communication with the storage and the interface and configured to:
determine a current concentration of the cuttings in the drilling operation at least near the drill tool based on the obtained parameters;
determine a desired rate of penetration for the drilling operation based on the determined concentration correlated with the historical information; and
alter a current rate of penetration based on the determined rate.
